(19) United States
(12) Patent Application Publication
(10) Pub. No.: US 2023/0256270 A1
(43) Pub. Date: Aug. 17, 2023

(54) PERSONAL WEARABLE AIR CURTAIN SHIELD

(71) Applicants: WISDOME WEARABLES LTD., Kibbutz Naan (IL); Technion Research & Developement Foundation Ltd., Haifa (IL)

(72) Inventors: Moshe SHOHAM, Hoshaya (IL); David KEISAR, Haifa (IL); Anan GARZUZI, Haifa (IL); David GREENBLATT, Haifa (IL)

(21) Appl. No.: 18/016,475

(22) PCT Filed: Jul. 15, 2021
(86) PCT No.: PCT/IB2021/056404

§ 371 Date: Jan. 17, 2023

Related U.S. Application Data
(60) Provisional application No. 63/052,158, filed on Jul. 15, 2020.

(51) Int. Cl. A62B 18/00; A42B 1/017; A62B 23/02; A62B 18/08

(52) U.S. Cl. CPC A62B 18/003; A42B 1/017; A62B 23/02; A62B 18/08

(57) ABSTRACT

A device in the form of a cap, for generating an isolation barrier for airborne pathogens between the wearer's face and the environment. A major part of the outer surface comprises filter material, allowing filtered air to flow from the environment into a chamber beneath the surface layer. A fan sucks air through the filter element and into the chamber. A horizontally oriented slot is situated across the visor portion of the cap structure, in front of the forehead of the person when the device is worn by the person. The slot has a width substantially smaller than the length. The flow of filtered air within the chamber is directed out of the slot as a curtain-like flow of filtered air in front of the face of the person. A cross-flow fan mounted just above the slot is most effective in generating the curtain flow.

### FIELD

The present disclosure describes technology related to the field of protection from airborne pathogens, especially devices using an air curtain to provide an isolation barrier from the environment.

### BACKGROUND

There are known in the art, many types of protective masks, for isolating the wearer from the air of the surrounding environment, and to prevent the wearer from contaminating the surrounding environment. Since masks made of filtering material are uncomfortable, and their efficiency is very dependent on the manner in which they are worn, a number of masks have been described, which use a high speed air curtain to generate the isolation barrier between the wearer and the environment.

Some such air curtain devices are shown in the following patent documents:
U.S. Pat. No. 5,048,516 to S. Söderberg et al, for “Respiratory Mask”.
US published patent application No. 2013/0118506 to O.I.Osipov et al, for “Method for protecting breathing organs and eyes from aerosols and device for implementing the same”, and several further references cited therein.

In addition, in the article entitled “Study of an Air Curtain in the Context of Individual Protection from Exposure to Coronavirus (SARS-CoV-2) Contained in Cough-Generated Fluid Particles” by A. S. Sakharov et al, published in Physics, 2020, No. 2, pages 340-351, there is expounded the requirements and efficiency of such an air curtain barrier, with regard to the currently on-going COVID-19 viral propagation.

However, it is believed that each of the above referenced publications has one or more disadvantageous aspects in the use or efficiency of the suggested solutions.

The disclosures of each of the publications mentioned in this section and in other sections of the specification, are hereby incorporated by reference, each in its entirety.

### SUMMARY

The present disclosure attempts to provide novel systems and methods that overcome at least some of the disadvantages of prior art systems and methods. The present disclosure describes a head-worn device capable of producing a curtain-shaped jet of air such that the air behaves as a dynamic barrier that protects the wearer from airborne or aerosolized pathogens, such as pathogen-laden fluid micro-drops suspended in the air around the wearer of the device, or even inadvertently projected towards the wearer of the device, and assures that the user is able to inhale filtered air substantially clean of pathogens. Additionally, it displaces towards the floor, pathogen-laden fluid micro-drops expelled orally or nasally by the wearer of the device, preventing them from being expelled outwardly over a wide area surrounding the wearer, and thus preventing the contamination of the immediate surroundings of the person emitting the pathogens. Pathogens which are directed downwards towards the floor, well below the inhalation orifices and eyes of others in the vicinity, will have a much reduced likelihood of being inhaled by others.

The device, which may be referred to as an air-shield generator, may resemble a cap-shaped headwear, with a fan capable of drawing in environmental air, and forcing it through a long, narrow, rectangular shaped slot, or alternatively, any other suitably shaped slot, such that a high speed flow of air is produced. This acts as an air curtain shielding the wearer's nose, mouth, and eyes, from droplets which may be suspended in the air around the wearer of the device.

Since the air used to generate the air curtain, as described above, travels past the nose, mouth and eyes of the wearer of the device, it is important that the air curtain does not contain pathogen-laden fluid droplets. Should the air curtain shield contain infected droplets, such fluid droplets may accidently be directed towards the eyes, nose or mouth of the wearer, or towards objects held near the face, such as a phone. This could occur if there is any perturbation of the air flow, such as by the user passing an object or a hand through the air flow, which would deflect it in many directions. Furthermore, a draught of air, such as when opening a door, could also direct the air flow towards the wearer's face. Additionally, if there were infected droplets in the air curtain, even though those infected droplets are directed downwards towards a space less likely to cause transmission of the infection, they may still be projected outside of the air flow curtain as the curtain loses its kinetic energy, and may thus still infect others in proximity to the wearer of the air curtain shield. Thus a filter designed to remove such infected droplets is important, such that the air curtain produced by the device comprises filtered, non-contaminated air.

In order to provide effective filtration of the air for the air curtain shield, an adequate filter is needed to ensure that pathogen-laden fluid particles are trapped as much as possible in the filter. Filters known as HEPA filters (High Efficiency Particulate Air) are often used for this purpose, however any other such filter may also be used. A disadvantage of such filters is that, in order to efficiently perform their filtering function, they necessarily have a high resistance to air flow. A high flow rate is required to produce the high speed air curtain of the present application. In those circumstances, a high resistance filter in the flow path will limit the throughput of the fan used to generate the high speed air flow. In order to overcome this limitation, a large fan would generally be required in order to produce the throughput required. However, such a large fan would be unwieldly in a head-borne protective mask, and would require a higher power level to operate. This would require a large capacity energy source, such as comparatively larger batteries, and would be make the device unsuitable or uncomfortable to wear. Alternatively, if more compact batteries were to be used, the battery charge would be utilized at a rate which may not provide a sufficiently useful operational time.

The presently described devices overcome this problem by utilizing as large an area of filtration as is conveniently possible, such that the overall resistance of the filters to air flow, resulting from the increased filter area, is minimized. The lower resistance to the airflow level required enables the use of a smaller fan operating at a lower power level, such that batteries with a smaller charge capacity, and hence physically smaller size, can be used. As a result, the air-shield generator can be a lighter weight, lower powered, and easier-to-wear device, when compared with previously available air curtain masks.

Such an air-shield generator can be formed as a head mounted, cap-shaped device, that shape enabling the provision of an area on the outer surface of the cap, large enough for the filtration area required. Typically, the filtration may be achieved by use of a single appropriately shaped filter embedded in or attached to the outer surface of the device, preferably with narrow support struts internal to the filter in order to provide protection to the filter shape from external physical blows and to safeguard the required space for smooth air flow within the filtered air chamber. Alternatively, a number of conveniently sized filters may be mounted over the outer surface of the cap-shaped device.

The air flow generated by the fan may be directed towards an elongated narrow slot, situated at the front of the cap such that it is located in the forehead region of the wearer, and directed downwards. The narrow slot has an approximately horizontal orientation, preferably angled slightly outwards, to prevent it from passing too close to the user's face, such that a high speed flow of air is generated, directed past the face of the wearer, thus providing the required protection.

In order to determine the optimal fan type to use in the present device, the advantages and disadvantages of different fan types are now considered. Since no fan type can combine the characteristics of high volume flow, a higher output air pressure and does so more efficiently than other types, a trade-off of fan properties must be made in order to select the correct type of fan for this application. Thus, though axial fans have the highest efficiency of commonly used fans, and can provide a high volume flow rate, the pressure that they generate is low, and the air is distributed over a comparatively wide area. Radial or tangential or cross-flow fans, on the other hand, generate air at a higher pressure but not at a large flow rate. That means that they create a steady if more modest flow of air, but one that can be used to target a concentrated area. Thus although such fans are less efficient than axial fans, their high pressure characteristics, and their special physical feature of being able to generate a wide jet of air, without the need for excessive concentration into a narrowly shaped flow stream, makes them the preferred choice in the devices of this application. An added advantage of cross-flow or tangential fans is that they generate a substantially lower noise level than many other types of fans, and especially in head-mounted devices, such a low-noise device will be very advantageous.

Therefore, cross-flow or tangential flow fans are preferred for this application because they produce a good balance between pressure and volumetric flow-rate and at a comfortable noise level. Such fans are called cross-flow fans hereinafter.

The main challenge involves integrating the fan onto, or into, the visor at the front of the cap. In order to fulfil the requirements mentioned above, the fan is mounted as low as possible on the visor without losing performance and without impeding the vision of the wearer. This is because the peak velocity of the air stream decreases with the inverse of the square-root of the distance from the fan. To maximize performance, an inlet guide vane (IGV) ensures smooth airflow from the volume between the visor and cap filter and material. Without a correctly designed IGV the fan performance, i.e. jet velocity for a given electrical power input, is less than optional.

Thus, two characteristics which contribute to the successful performance of the devices of the present disclosure are the use of as large an area filter as is possible for the input air, which is achieved by utilizing as large an area as possible of the cap for filtering purposes, and the use of a fan having characteristics which enable it to generate a high speed curtain of that filtered air.

There is thus provided in accordance with an exemplary implementation of the devices described in this disclosure, a head-mounted device for generating an isolation barrier for airborne pathogens between a person and the environment, the device comprising:

(i) an outer surface layer enclosing at least one chamber between itself and the person's head,
(ii) at least one filter element mounted in the outer surface layer, the filter element adapted to allow passage of filtered air from the environment into the at least one chamber,
(iii) a fan adapted to produce a flow of filtered air through the at least one filter element and into the at least one chamber, and
(iv) a lateral slot situated in the lower forward region of the chamber, in a position that is in front of the forehead of the person when the device is mounted on the head of the person, the length of the slot extending laterally across the device, and the slot having a width smaller than the length, such that the flow of filtered air within the at least one chamber is directed out of the slot as a flow of filtered air in front of the face of the person,
wherein the at least one filter element occupies a substantial part of the outer surface layer, such that the resistance of the at least one filter element to the air flow therethrough, is minimized.

In any such device, the at least one chamber may comprise a single chamber, and the blower fan may be a cross-flow fan disposed in close proximity to the slot, such that it collects the filtered air from the single chamber and passes it into the slot. In such a case, the fan may be mounted in a visor at the forward end of the device, with the front-most end of the visor operative as an inlet guide vane to the cross-flow fan. The inlet vane guide should then have a smooth internal profile, to assist in the efficient flow of air into the fan. Alternatively, the fan may be mounted in the forward end of the visor, with the inlet aperture facing the internal chamber.

In any of the above described devices, the at least one filter element may comprise a number of separate filter elements mounted in the outer surface layer. Alternatively, the at least one filter element may comprise a single filter element covering at least a substantial part of the area of the outer surface layer. That substantial part of the area of the outer surface layer may be 50%, or more preferably 75% or most advantageously 90%.

The above described devices may advantageously be battery operated, and therefore should have a battery holder configured to receive at least one battery for powering the fan. The at least one battery may be a chain of batteries mounted in a rim of the device.

In an alternative configuration of the above described devices, the at least one chamber may comprise an outer chamber and an inner chamber separated by a partition wall, and the blower fan may then be an axial fan mounted in the partition wall, such that it collects the filtered air from the outer chamber and transfers it into the inner chamber for conveying to the slot.

There is further provided in accordance with yet another exemplary implementation of the devices described in this disclosure, a head mounted cap for generating an isolation barrier for airborne pathogens between a person and the environment, the cap comprising:

(i) an internal chamber beneath the outer surface, having fluid communication with the air around the cap through an area of filter material, thereby allowing passage of filtered air from the environment into the at least one chamber, and
(ii) a fan adapted to project a flow of filtered air from the chamber through a lateral slot situated in the bottom surface of a visor of the cap, such that the flow of filtered air within the at least one chamber is directed out of the slot as a curtain-like flow of filtered air in front of the face of the person,
wherein the area of filter material occupies a substantial part of the outer surface, such that the resistance of the area of filter material to the air flow therethrough, is minimized.

In any such a cap, the fan may be a cross-flow fan disposed in close proximity to the slot, such that it collects the filtered air from the internal chamber and passes it into the slot. In such a case, the fan may be mounted in a visor at the forward end of the cap, with the front-most end of the visor operative as an inlet guide vane to the cross-flow fan. The inlet vane guide should then have a smooth internal profile, to assist in the efficient flow of air into the fan. Alternatively, the fan may be mounted in the forward end of the visor, with the inlet aperture facing the internal chamber.

In any of the above described caps, the at least one filter element may comprise a number of separate filter elements mounted in the outer surface. Alternatively, the at least one filter element may comprise a single filter element covering at least a substantial part of the area of the outer surface. That substantial part of the area of the outer surface may be 50%, or more preferably 75% or most advantageously 90%.

The above described caps may advantageously be battery operated, and therefore should have a battery holder configured to receive at least one battery for powering the fan. The at least one battery may be a chain of batteries mounted in a rim of the cap.

### BRIEF DESCRIPTION OF THE DRAWINGS

The present invention will be understood and appreciated more fully from the following detailed description, taken in conjunction with the drawings in which:

FIG. 1 illustrates schematically an exemplary device of the type described in the present disclosure, incorporating useful features of the presently described devices;

FIG. 2 shows a view of the cap described in FIG. 1, from its inside top surface, showing a large area filter element in the shape of the cap, providing the high throughput required;

FIG. 3 shows how the filtering area may be alternatively implemented to that shown in FIG. 2, by having a number of separate filters mounted in apertures formed in the outer surface of the cap;

FIG. 4 illustrates schematically an alternative exemplary device incorporating more useful features of the presently described devices; and

FIG. 5 illustrates schematically a device similar to that of FIG. 4, but having an alternative location and orientation of the fan in the visor of the device.

### DETAILED DESCRIPTION

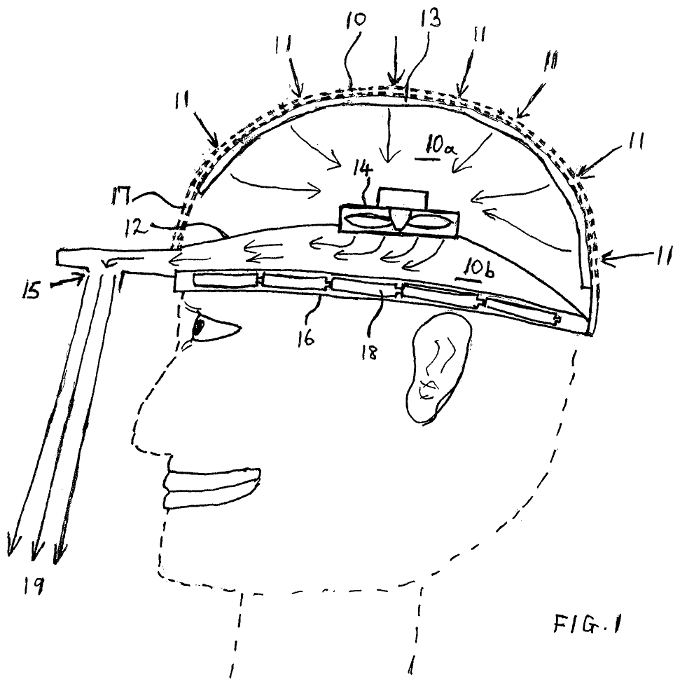

Reference is first made to FIG. 1 which illustrates schematically a cross sectional view of an exemplary device of the type described in the present disclosure, incorporating the inventive features of the presently described devices. The device representation is schematically drawn to show the internal structure of its component parts.

The air-shield generator of FIG. 1 is shown having the form or shape of a helmet or a stiff baseball cap, hereinafter described as a cap, such that the device can comfortably sit on the user's head. The outer shell of the cap 17 may be made of a stiff or semi-stiff material, having openings in its structure, to allow an air flow 11 through it. In FIG. 1, those openings are provided by a porous structure, though alternative implementations could have a few larger openings, as will be shown hereinbelow. The exemplary cap shown in FIG. 1 comprises two chambers, outer chamber 10a and inner chamber 10b, separated by a partition wall 12, the inner chamber also acting as an inner passageway. The outer chamber 10a is formed by the outer surface 17 and the partition wall 12. The outer surface 17 has an HEPA filter 13, or another high-quality mask filter, attached to its inner surface, through which air 11 is allowed to pass into the outer chamber 10a, but which traps pathogen-infected droplets or aerosol mist, suspended in the environmental air. The filter is shown covering a substantial part of the area of the outer surface of the cap, and the larger the percentage cover, the less resistance there will be to the input air flow, and the lower the power needed by the blower fan. Coverage of more than 50% is desirable, at least 75% even more desirable, and coverage of 90% or more is even more optimal.

In order to produce the flow of air needed to generate an air curtain shield 19, the partition element 12 comprises a blower fan 14, designed to draw filtered air entering the chamber 10a into inner passageway 10b, which conveys the air towards an exit slot 15 disposed at the front end of the passageway. The fan 14 may advantageously be situated towards the center or rear end of the partition wall 12, such that the high speed stream of air entering the inner passageway 10b flows with less turbulence towards the slot 15. The inner passageway 10b may be formed by the partition wall 12 and the inner lining 16 which contacts the user's head.

The fan 14 may be an axial fan, with the axis of the fan generally perpendicular to the partition wall 12. The air driven into the lower compartment 10b, is forced to the exit at the front of the compartment where the long and narrow slot 15 across the width of the cap is positioned such that it directs the air flow out of the cap in a fast-moving stream 19 in a downwards direction past the eyes, nostrils and mouth of the user. The transition between the internal passageway and the slot should be dynamically smoothed to maintain a smooth flow as best as possible. The slot in the visor of the cap may be advantageously oriented such that the air curtain 19 is directed downwards at a small angle away from the face, so that the air stream does not impact the nose and partly disperse in a direction lateral to the desired downward flow direction.

The fan 14 should be battery driven, with batteries 18 optionally disposed at a convenient location on the cap, such as around the rim, or at the back base of the cap. Alternatively, the fan may be connected by wire to a battery pouch carried by the user. According to an exemplary implementation, the batteries may be charged by solar photoelectric cells (not shown in FIG. 1).

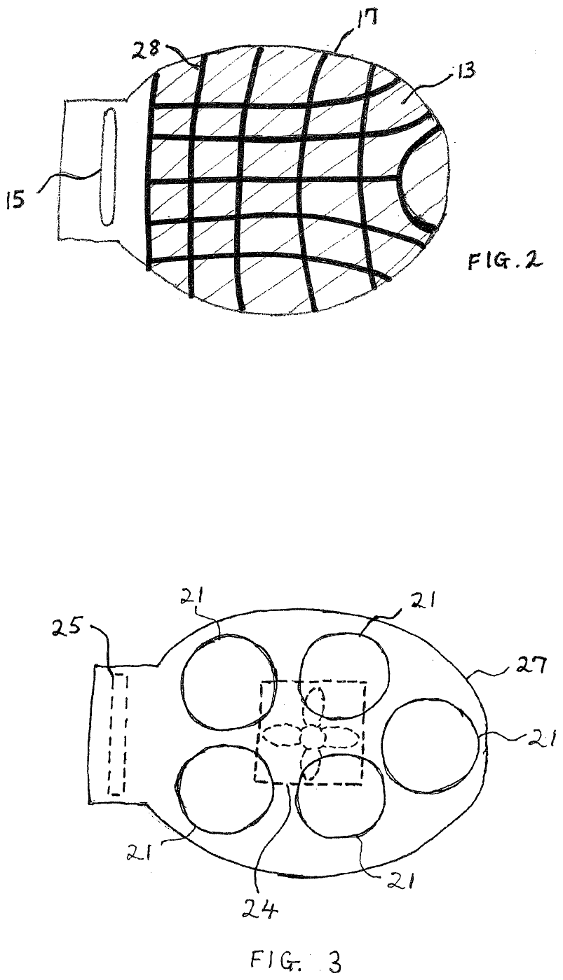

Reference is now made to FIG. 2 which shows a view of the cap described in FIG. 1, from its inside top surface 17, showing a large area filter element 13 in the shape of the cap, providing the high throughput required. Suitable internal ribs 28 are used to maintain the shape of the filter and its covering material, and to prevent them from being misshapen by external blows or even simple inadvertently applied pressure. Such shape maintenance is important to maintain sufficient cross section in order to maintain a smooth flow in the chamber, and to prevent increased airflow resistance. The filter, or filters should cover as large an area of the outer surface 17, as is possible, or as is needed, to provide as low a resistance to the airflow as is possible.

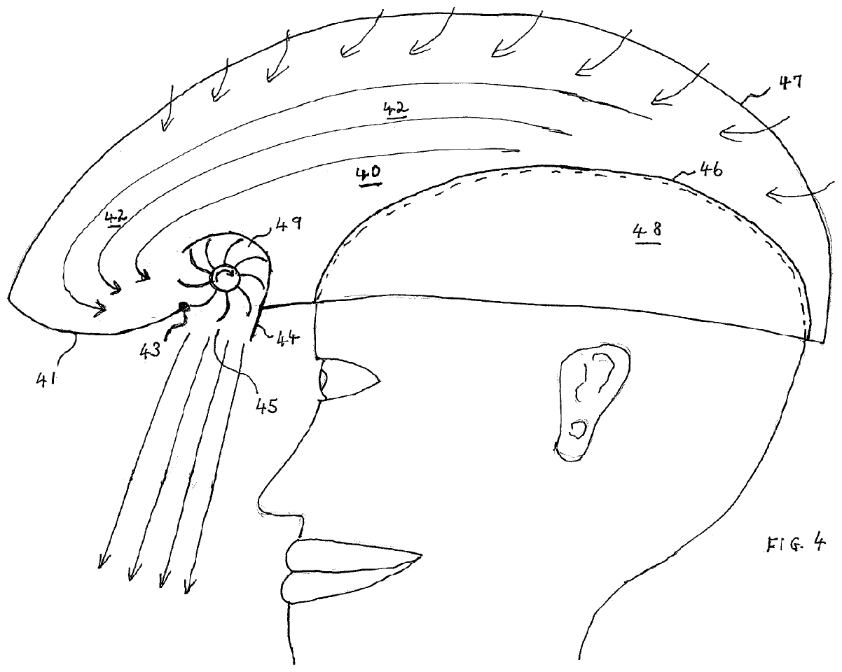

Reference is now made to FIG. 3, in which the filtering area is alternatively implemented by having a number of separate filters 21 mounted in apertures formed in the outer surface 27 of the cap. The fan 24 is shown positioned in the center of the cap's partition wall, though it is to be understood that it could be in alternate positions. It should be noted that because of the use of such a large filtration area, the resistance to airflow of filters is minimized, such that the fan can be of moderate size thereby reducing its power consumption, and thereby providing longer operation of a single battery charge. At the front of the cap, the slot 25 for generating the air curtain shield is shown.

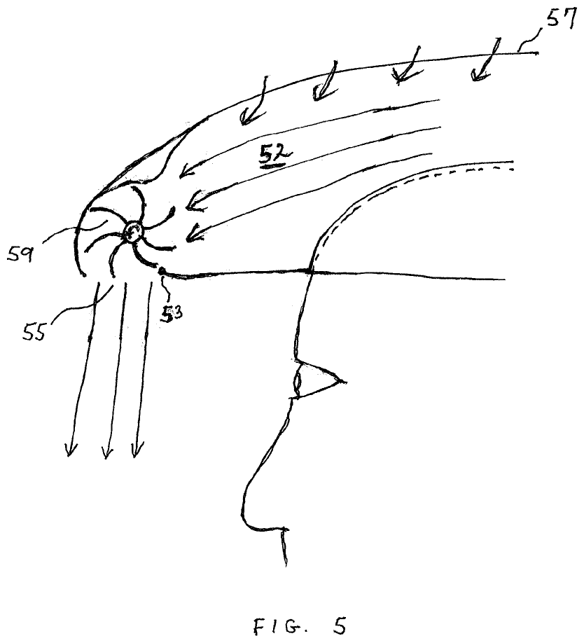

Reference is now made to FIG. 4, which illustrate schematically an alternative exemplary device incorporating other useful features of the presently described devices. Those details not directly related to the improvement of the device of FIG. 4 over that of FIG. 1, have been omitted to simplify the drawing.

In a similar manner to the implementation shown in FIG. 1, the air-shield generator of FIG. 4 is also shown having the form of a cap, or baseball cap such that the device can comfortably sit on the user's head.

The air-shield generator described in FIG. 1 involves a long passageway through which the forced air must pass from the fan 14 before reaching the exit aperture 25. The result of such a long passageway is loss of flow velocity and lower efficiency. The cap of FIG. 4 shows how this disadvantage can be overcome, by mounting a cross-flow fan as close as possible to the exit aperture, such that the air flow is fast and spatially concentrated. Cross-flow fans are ideal for this application because they produce a good balance between pressure and volumetric flow-rate, with medium specific speeds. In other words, cross-flow fans can input air through the filters, overcoming the pressure loss, and deliver a strong jet through the output aperture 45. Moreover, cross-flow fan impellers may be constructed from segments of staggered forward-facing blades similar to concatenated squirrel cage impellers. This is what gives them their high aspect ratio. i.e. the length/impeller diameter, and the ability to produce a rectangular jet. The segmentation also provides strength and reduced noise due to the blade staggering.

In the exemplary embodiment of FIG. 4, the air-shield generator comprises only a single chamber 40, formed between the outer surface 47 through which the filtered air is drawn, and the inner shell 46, which sits on the scalp or hair of the wearer 48. Alternatively, chamber 40 may be formed by outer surface 47, and the head of the wearer 48 of the device, in which case the outer surface should have sufficient stiffness to maintain the shape and stability of the cap on the user's head.

The cap has a long visor at its front end, with a cross-flow fan 49, embedded in the visor. The fan lies horizontally, such that the long axis of the fan is perpendicular to the imaginary axis formed by the eyes, nose and chin of the wearer. The fan 49 is disposed parallel to the length of the slot 45, and as close as possible to the slot, as is shown in FIG. 4. The inlet guide vane 41 leading to the fan tongue 43 should be formed having as smooth an internal profile as possible, without sharp corners or bends, to minimize the flow impedance presented to the air flow. This ensures that the smooth air flow 42 within the air input chamber 40 is also maintained into the fan 49. The fan tongue itself is shown in this exemplary implementation as a rod at the end of the inlet guide vane, running across the span of the fan outlet, generating the tongue vortex.

The slot 45 through which the air curtain is established, may typically have dimensions of 1 cm. width and 10 cm. length. A protection lip 44 may be provided to keep the flow stream from being positioned too close to the wearer's face. A flow rate of 10 m/s is generally considered sufficient to enable the air curtain to provide adequate isolation safety. In order to generate such a flow rate through the above dimensioned slot, the fan should be able to generate an airflow rate of 10 liters per second, which translates into 21 cubic feet per minute (CFM), in the units generally used by fan manufacturers. Such a low power fan, when operated continuously for eight hours, would require a battery with a capacity of approximately 18 Watt hours. Such a capacity could be supplied, for instance, by eight lithium polymer batteries, such as model 284050, each of 600 mAh charge capacity and of 3.7V nominal output. Such batteries have a thickness of only 2 mm, and an area of 4 cm.×5 cm, such that a row of eight of them could readily be fitted around the rim of the cap, and, since they weigh a total of only 150 gm, would not be burdensome to the wearer.

Reference is now made to FIG. 5, which illustrates the forward end of the cap 57, showing an alternative location and orientation of the fan 59 in the visor. In the implementation of FIG. 5, the fan operates in the opposite direction, and inputs air from the chamber in the direction of its flow 52 within the chamber, before outputting the air in a high speed air curtain from the output aperture 55. The tongue 53 is positioned appropriately relative to the fan output. In this alternative embodiment, the fan and the output slot are located further forward than in the implementation of FIG. 4, this position having advantages and disadvantages which must be weighed up to decide on the optimum configuration to be used. Thus, while the air input from the chamber has a shorter and straighter path than in the example of FIG. 4, the output stream of air is located further from the face of the user, and therefore may be less effective. On the other hand, the visor may be shorter, since there is no need for the longer input air pathway, and a shorter visor may make use of the cap simpler. Similarly, the extent to which the fan projects downwards influences the level of limitation of the user's line of sight, and this may need to be different depending on the configuration used.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

It is also appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

We claim:

1. A device adapted to be mounted on the head of a person, for generating an isolation barrier for airborne pathogens between the person and the environment, the device comprising:
an outer surface layer enclosing at least one chamber between itself and the person's head;
at least one filter element mounted in the outer surface layer, the filter element adapted to allow passage of filtered air from the environment into the at least one chamber;
a fan adapted to produce a flow of filtered air through the at least one filter element and into the at least one chamber; and
a lateral slot situated in the lower forward region of the chamber, in a position that is in front of the forehead of the person when the device is mounted on the head of the person, the length of the slot extending laterally across the device, and the slot having a width smaller than the length, such that the flow of filtered air within the at least one chamber is directed out of the slot as a flow of filtered air in front of the face of the person,
wherein the at least one filter element occupies a substantial part of the outer surface layer, such that the resistance of the at least one filter element to the air flow therethrough, is minimized.

2. The device according to claim 1, wherein the at least one chamber comprises a single chamber, and the blower fan is a cross-flow fan disposed in close proximity to the slot, such that it collects the filtered air from the single chamber and passes it into the slot.

3. The device according to claim 2, wherein the fan is mounted in a visor at the forward end of the device, with the front-most end of the visor operative as an inlet guide vane to the cross-flow fan.

4. The device according to claim 2, wherein the fan is mounted in the forward end of the visor, with the inlet aperture facing the internal chamber.

5. The device according to claim 3, wherein the inlet vane guide has a smooth internal profile, to assist in the efficient flow of air into the fan.

6. The device according to any one of the previous claims, wherein the at least one filter element comprises a number of separate filter elements mounted in the outer surface layer.

7. The device according to any one of previous claims 1 to 5, wherein the at least one filter element comprises a single filter element covering at least a substantial part of the area of the outer surface layer.

8. The device according to claim 7, wherein the substantial part of the area of the outer surface layer is 50%.

9. The device according to claim 7, wherein the substantial part of the area of the outer surface layer is 75%.

10. The device according to claim 7, wherein the substantial part of the area of the outer surface layer is 90%.

11. The device according to any of the previous claims, adapted to receive at least one battery for powering the fan.

12. The device according to claim 11, wherein the at least one battery is a chain of batteries mounted in a rim of the device.

13. The device according to claim 1, wherein the at least one chamber comprises an outer chamber and an inner chamber separated by a partition wall, and the blower fan is an axial fan mounted in the partition wall, such that it collects the filtered air from the outer chamber and transfers it into the inner chamber for conveying to the slot.

14. A head mounted cap for generating an isolation barrier for airborne pathogens between a person and the environment, the cap comprising:
an internal chamber beneath the outer surface, having fluid communication with the air around the cap through an area of filter material, thereby allowing passage of filtered air from the environment into the at least one chamber; and
a fan adapted to project a flow of filtered air from the chamber through a lateral slot situated in the bottom surface of a visor of the cap, such that the flow of filtered air within the at least one chamber is directed out of the slot as a curtain-like flow of filtered air in front of the face of the person,
wherein the area of filter material occupies a substantial part of the outer surface, such that the resistance of the area of filter material to the air flow therethrough, is minimized.

15. The cap according to claim 14, wherein the fan is a cross-flow fan disposed in close proximity to the slot, such that it collects the filtered air from the internal chamber and passes it into the slot.

16. The cap according to claim 15, wherein the fan is mounted in a visor at the forward end of the cap, with the front-most end of the visor operative as an inlet guide vane to the cross-flow fan.

17. The cap according to claim 15, wherein the fan is mounted in the forward end of the visor, with the inlet aperture facing the internal chamber.

18. The cap according to claim 16, wherein the inlet vane guide has a smooth internal profile, to assist in the efficient flow of air into the fan.

19. The cap according to any one of claims 14 to 18, wherein the at least one filter element comprises a number of separate filter elements mounted in the outer surface layer.

20. The cap according to any one of previous claims 14 to 18, wherein the at least one filter element comprises a single filter element covering at least a substantial part of the area of the outer surface layer.

21. The cap according to claim 20, wherein the substantial part of the area of the outer surface layer is 50%.

22. The cap according to claim 20, wherein the substantial part of the area of the outer surface layer is 75%.

23. The cap according to claim 20, wherein the substantial part of the area of the outer surface layer is 90%.

24. The cap according to any of claims 14 to 23, adapted to receive at least one battery for powering the fan.

25. The cap according to claim 24, wherein the at least one battery is a chain of batteries mounted in a rim of the cap.
